(19) United States
(12) Patent Application Publication
(10) Pub. No.: US 2008/0224418 A1
(43) Pub. Date: Sep. 18, 2008

(54) Rotary Valve Internal Combustion Engine and Seal Arrangement

(76) Inventor: Keith Trevor Lawes, Dorset (GB)

Correspondence Address: John Wiley Horton;Pennigton, Moore , Wikinson,Bell & Dunbar, 215 S Monroe St. 2nd Floor, Tallahassee, FL, 32312, US

(21) Appl. No.: 11/628,065

(22) PCT Filed: May 25, 2005
(86) PCT No.: PCT/GB05/02053

§ 371 Date: Feb. 8, 2007

(30) Foreign Application Priority Data
Jun. 2, 2004 (GB) 0412275.0

(51) Int. Cl. F02F 11/00

(52) U.S. Cl. 277/591

(57) ABSTRACT

A seal arrangement for a rotary valve internal combustion engine having a cylinder 1 including a valve port 7 in communication with a combustion chamber 5, the cylinder 1 being rotatable about its longitudinal axis 1a in a cylindrical bore 8 of a valve housing 9, the valve housing having an inlet port 10 and an outlet port adapted to be aligned successively with said valve port 7 during rotation of the cylinder 1 in the housing 9 to enable fluid to flow respectively into and out of the combustion chamber 5. The seal arrangement forms a seal around the valve port 7 between the cylinder and a concentric surface, and comprises a seal element 12 located in a recess 11 in said cylinder, fluid pressure in said valve port 7 acting on said seal element 12 to urge the seal element into contact with the said concentric surface and outwardly from the centre of the port into contact with the periphery 7b of said recess 11.

The present invention relates to a seal arrangement for a rotary valve internal combustion engine having a cylinder including a valve port in communication with a combustion chamber, the cylinder being rotatable about its longitudinal axis in a cylindrical bore of a valve housing, the valve housing having an inlet port and an outlet port adapted to be aligned successively with said valve port during rotation of the cylinder in the housing to enable fluid to flow respectively into and out of the combustion chamber.

Such rotating cylinder valve engines are known, for example from PCT/GB 01/04304 and PCT/GB 2003/002136. Such engines have a rotatable cylinder closed at one end to define, in part, a combustion chamber and an open end with a reciprocating piston disposed within the cylinder. The reciprocating piston rotates the cylinder through a gear mechanism so that the valve port is brought successively into alignment with an inlet port and an outlet port in a fixed valve housing to form a conventional four stroke internal combustion engine. Such engines have generally not been commercially successful because of the difficulty of providing an adequate sealing mechanism between the port formed in the rotating cylinder and the valve housing. Being adjacent to the combustion chamber, the sealing mechanism is subjected to large thermal stresses, high gas pressures and high surface speeds surface speeds with little or no lubrication.

The present invention seeks to provide a solution to these problems.

According to one aspect of the present invention there is provided a seal arrangement for a rotary valve internal combustion engine having a cylinder including a valve port in communication with a combustion chamber, the cylinder being rotatable about its longitudinal axis in a cylindrical bore of a valve housing, the valve housing having an inlet port and an outlet port adapted to be aligned successively with said valve port during rotation of the cylinder in the housing to enable fluid to flow respectively into and out of the combustion chamber, the seal arrangement forming a seal around the valve port between the cylinder and a concentric surface, and comprising a seal element located in a recess in said cylinder, the radially outermost surface of the sealing element forming a seal with the concentric surface and the outer surface (with respect to the axis of the port) of the sealing element forming a static seal with the periphery of said recess, and wherein fluid pressure in said valve port acts on said seal element to urge the seal element into contact with the said concentric surface and outwardly from the centre of the port into contact with the periphery of said recess.

In this specification the term sliding seal is used to refer to a seal between a seal component and a body moving relative thereto and the term static seal is used to refer to a seal between a seal component and a body with which no relative sliding sealing motion takes place.

According to a second aspect of the invention there is provided a rotary valve internal combustion engine having a cylinder including a valve port in communication with a combustion chamber, the cylinder being rotatable about its longitudinal axis in a cylindrical bore of a valve housing, the valve housing having an inlet port and an outlet port adapted to be aligned successively with said valve port during rotation of the cylinder in the housing to enable fluid to flow respectively into and out of the combustion chamber, wherein a sleeve concentric with the cylinder is rotationally fast thereto in such a way as to be able to float radially relative to the cylinder, the sleeve forming a floating sliding seal between the valve housing and the rotating parts.

In one form, the concentric surface comprises the cylindrical bore of the valve housing. In another form, the concentric surface comprises the inner surface of a sleeve concentric with the cylinder and engaged to the cylinder so as to be rotationally fast therewith.

In a preferred form, the sleeve is a close sliding fit in the cylindrical bore in the housing and, preferably, a predetermined annular gap is provided between the sleeve and the rotatable cylinder, the sleeve being fast to the cylinder so as to be able to float radially relative thereto.

In a preferred embodiment, a locating pin engageable in a bore in the sleeve is located in a bore in the cylinder, the pin being resiliently biased outwardly into engagement with the bore in the sleeve. In this embodiment, the cross-section of the outer end of the pin which enters the sleeve is preferably smaller than the cross-sectional area of the adjacent part of the pin to provide a shoulder adapted to abut the inner surface of the sleeve thereby to limit the degree of penetration of the pin into the sleeve. The pin is preferably circular in cross-section. The pin may be supported in the bore in the cylinder by a coil spring.

The sleeve may have a longitudinal slit which may extend throughout the length of the sleeve.

Preferably, the profile of the seal element is arcuate about the axis of the cylinder when viewed in the longitudinal direction of the cylinder. The seal element is preferably in the form of a resilient split ring and is resiliently biased into the periphery of said recess to provide a static seal designed to prevent gas leaking round the outside of the seal. In an alternative form, the seal is not split but is a very close fit in the recess to form the static seal.

Preferably, the seal element extends around the profile of the valve port and is a substantially constant distance from the periphery of the port. In this way, the seal is subjected throughout its length to substantially identical stresses caused by conditions in the port.

The seal element may comprise a substantially circular, or elliptical, split ring, which is uniform in cross-section.

In a preferred embodiment, the cylinder comprises two concentric sleeves rotationally fast together, the valve port comprising openings extending through the two sleeves, the opening in the outer sleeve being larger than the opening in the inner sleeve to thereby form said recess for the seal element, the recess being formed by the outer surface of the inner sleeve and the peripheral wall of the opening in the outer sleeve.

The inlet port may be inclined at an angle relative to a radial plane of the cylinder and its axis may extend radially inwardly or may be offset from the axis of the cylinder.

Preferably, a spring element is provided to bias the seal element into contact with said cylinder bore, which may comprise a wave spring washer having substantially the same profile as the seal element and which may be located in the recess between the seal element and the outer surface of the inner sleeve of the cylinder.

According to a third aspect of the invention, which may be used in combination with the first and/or second aspects, there is provided a seal arrangement for a rotary valve internal combustion engine having a cylinder including a valve port in communication with a combustion chamber, the cylinder being rotatable about its longitudinal axis in a cylindrical bore of a valve housing, the valve housing having an inlet port and an outlet port adapted to be aligned successively with said valve port during rotation of the cylinder in the housing to enable fluid to flow respectively into and out of the combustion chamber, the seal arrangement forming a seal around at least one of the inlet port and the outlet port between the valve housing and a concentric surface on the rotatable body, and comprising a seal element located in a recess in said valve housing, the radially innermost surface of the sealing element being arcuate about the axis of the cylinder and being resiliently biased towards the concentric surface, forming a seal with the concentric surface.

Preferably, sealing means is provided between the sealing element and the valve housing to minimise fluid leakage around the outer periphery of the sealing element.

In a preferred form, the sealing means comprises a sprung metal ring resiliently biased into contact with and forming a seal with a radially outer face of the sealing element, and being biased outwardly to form a seal with a peripheral surface of the recess.

Alternatively, the sealing means may comprise a plastics or rubber element resiliently biased into contact with and forming a seal with a radially outer face of the sealing element, and being biased outwardly to form a seal with a peripheral surface of the recess.

In another form, the sealing means may comprise a plastics or rubber element resiliently biased into contact with and forming a seal with a radially outer face of the sealing element and also forming a seal with an inner face of a second component mounted on the port radially outside the sealing element, compression of the sealing means also providing a resilient force to resiliently bias the said seal element into contact with the concentric surface.

In yet another form, the sealing means is provided by a plastics or rubber element located on an outer surface of the sealing element, forming a seal with said outer surface of the sealing element and a periphery of the recess.

In yet another form, the sealing means is provided by the sealing element being a close fit within the recess.

Preferred embodiments of the invention will now be described by way of example with reference to the accompanying drawings in which:

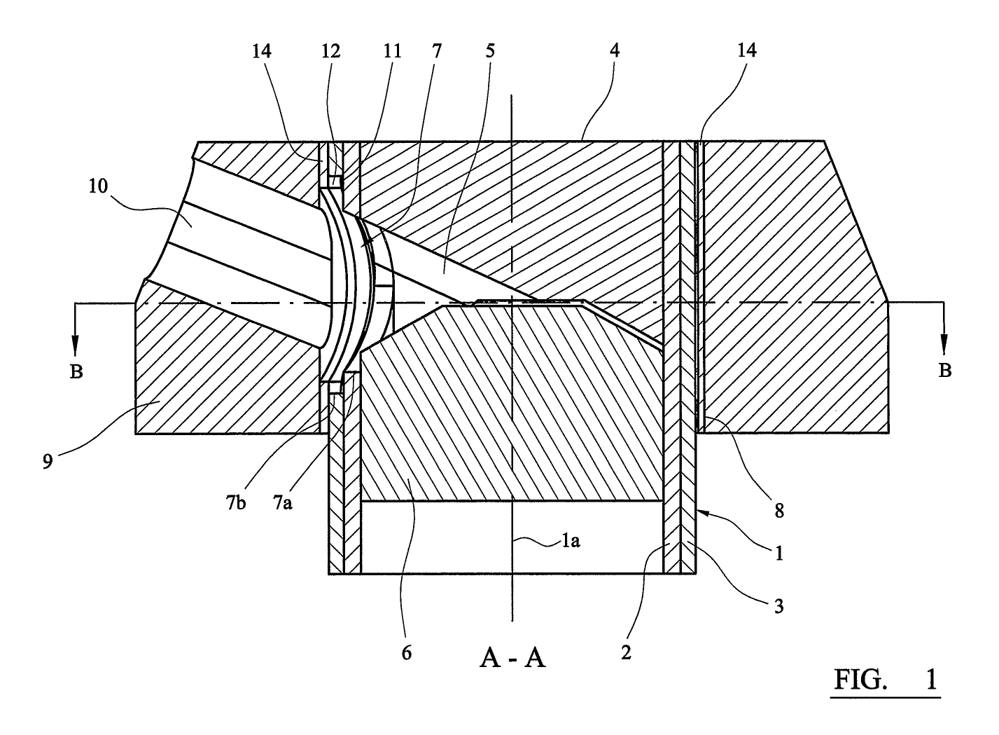

FIG. 1 shows a cross sectional view of part of a rotary cylinder valve internal combustion engine,

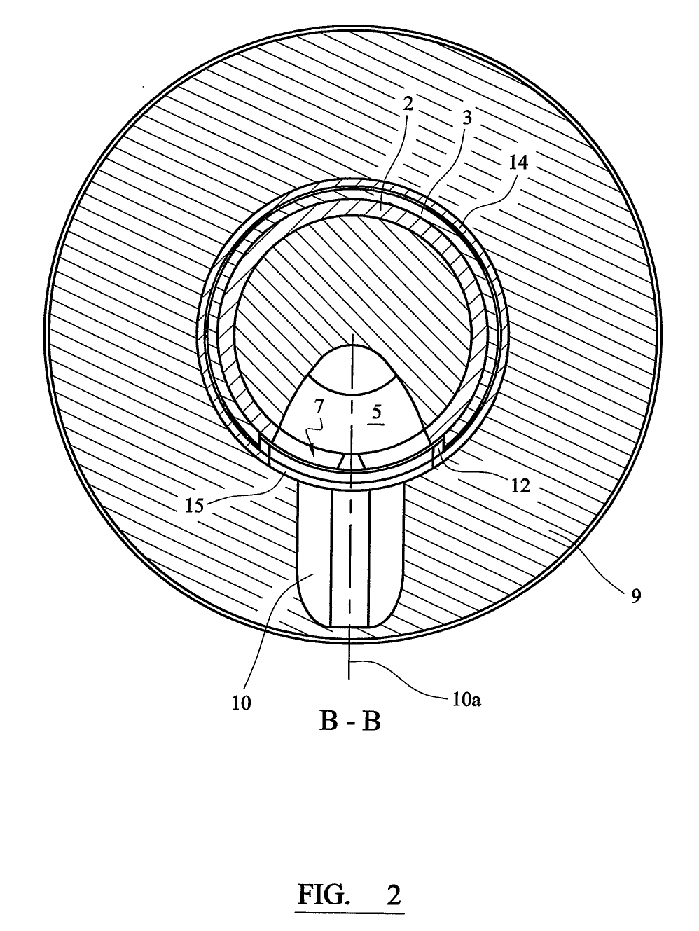

FIG. 2 shows a plan view along the line B-B of FIG. 1,

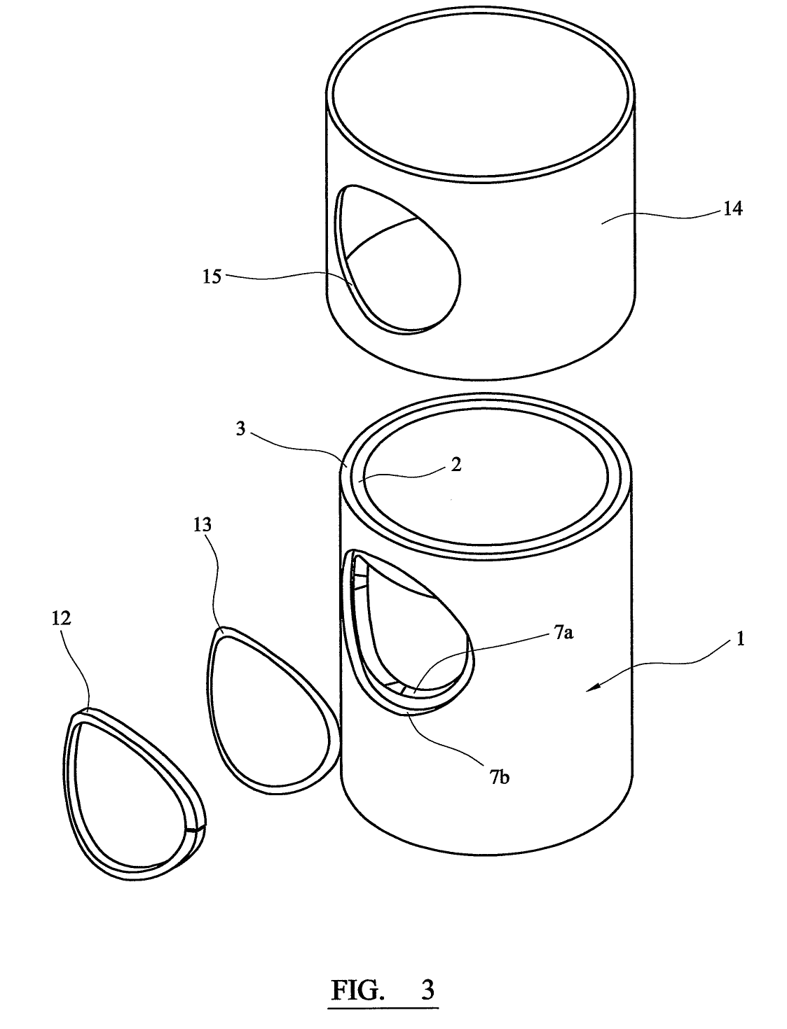

FIG. 3 shows an exploded perspective view of the cylinder and a seal arrangement,

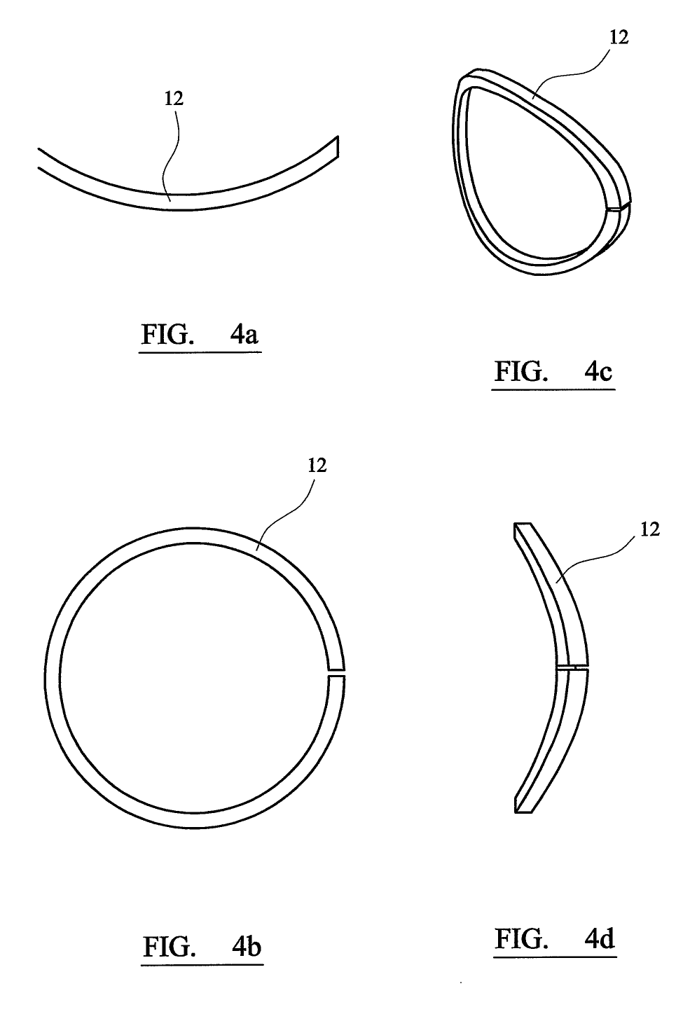

FIGS. 4a-4c show respectively, an end view, a front view, a perspective view and a side view of a resilient sealing ring,

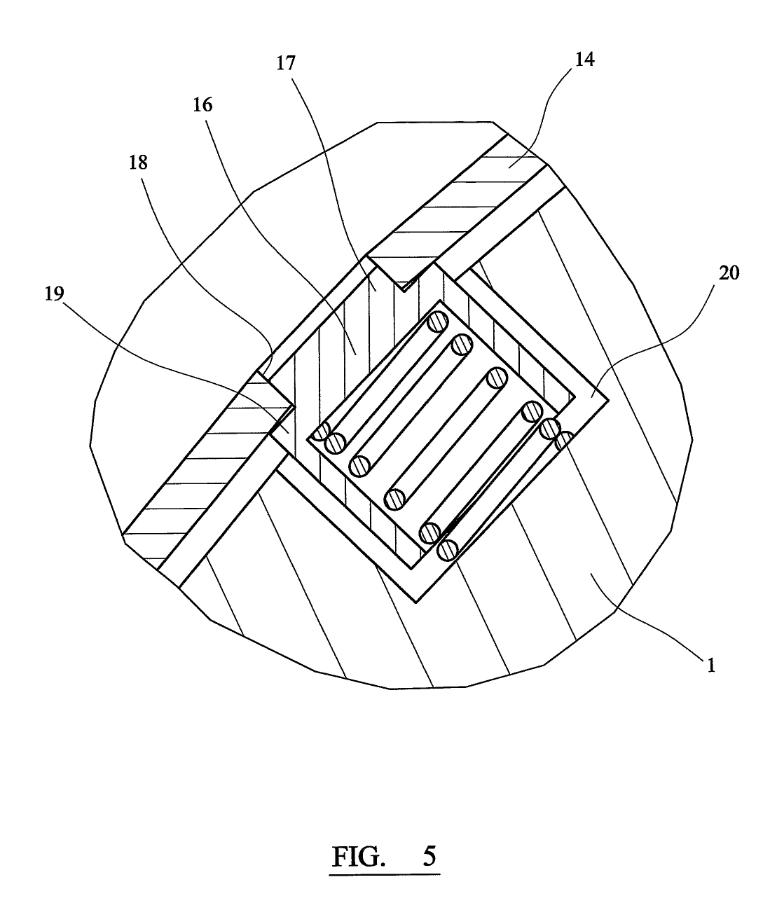

FIG. 5 shows a detail of the fastening of a sleeve to the rotary cylinder.

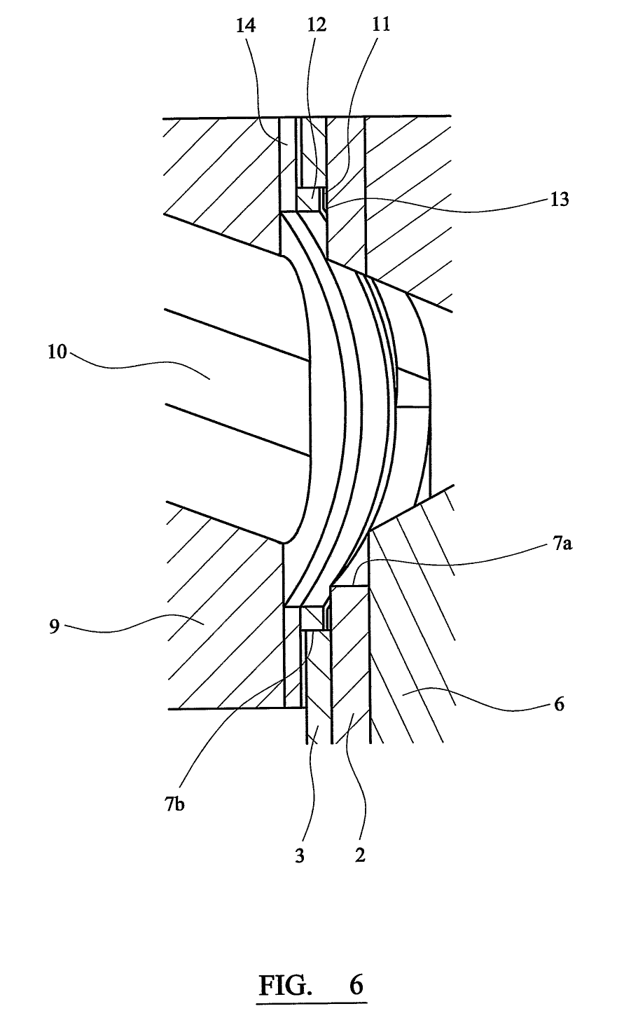

FIG. 6 shows an enlarged view of the seal shown in FIG. 1,

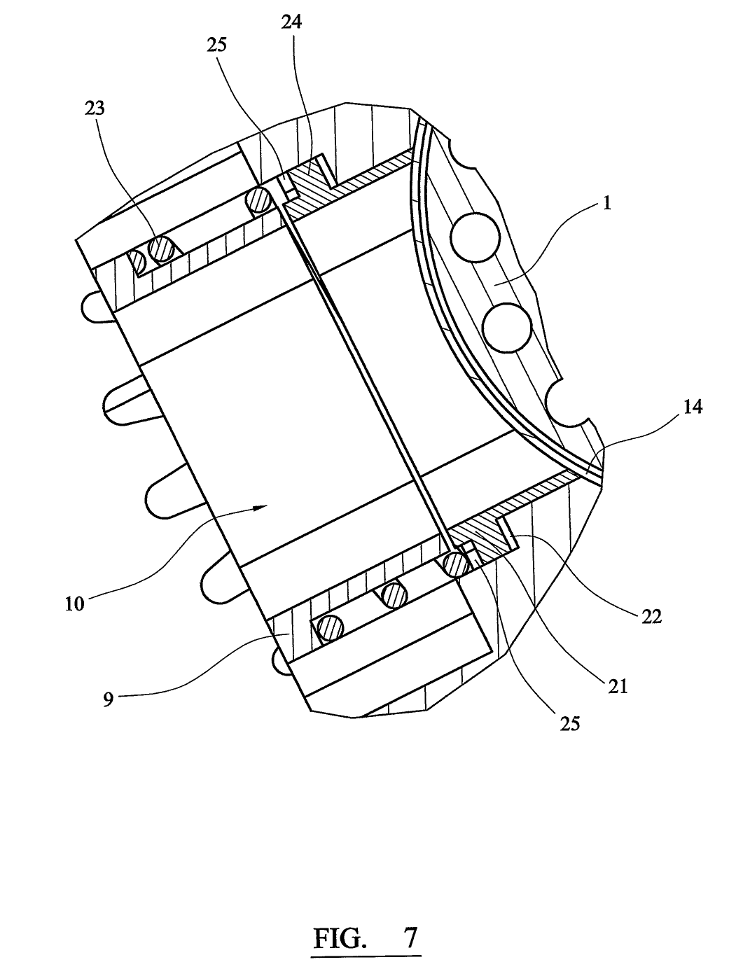

FIG. 7 shows a plan view of a further seal arrangement on the inlet port, and

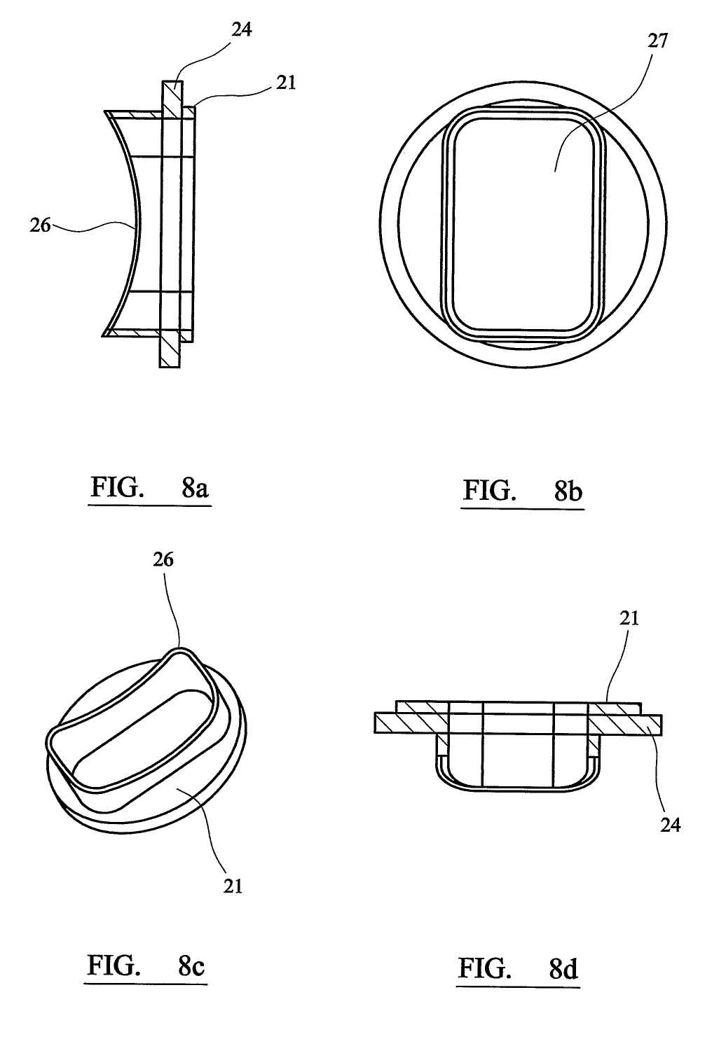

FIGS. 8a to 8d show respectively, side, front, perspective, and top sectional views of the seal of FIG. 7.

Referring now to FIGS. 1 and 2, there is shown a rotary cylinder internal combustion engine having a cylinder 1 formed of an inner sleeve 2 and an outer sleeve 3 rotationally fastened together. At its upper end 4, the cylinder 1 is closed to form a combustion chamber 5 between the closed end of the cylinder and a reciprocating piston 6. In the peripheral wall of the cylinder adjacent the combustion chamber 5, there is a valve port 7.

As shown in FIG. 3, the cylinder 1 has a concentric sleeve 14 which is rotationally fast with the cylinder and has in its periphery an opening 15 aligned with the valve port 7. An annular gap of approximately 0.2 mm is provided between the cylinder 1 and the sleeve 14 and the sleeve 14 is secured to the cylinder by a pin 16 projecting from a blind bore 20 in the cylinder as shown in FIG. 5 so as to be able to float radially relative to the cylinder to enable the gap to accommodate, for example, thermal expansion and any relative radial movement between the sleeve and the cylinder. The sleeve thus forms a floating sliding seal between the fixed housing 9 and the rotating cylinder 1.

The pin 16 is of circular cross-section and has a step with an outer end 17 of smaller diameter which is a close fit in a corresponding bore 18 in the sleeve, which forms a shoulder 19 adapted to abut the inner surface of the sleeve 14 to thereby limit the depth of engagement of the pin 16 in the sleeve 14. In this way, the pin 16 is prevented from projecting through the sleeve. The pin 16 has a bore containing a coil spring acting between the pin 16 and the bore 20 in the cylinder to bias the pin outwardly towards the sleeve 14. The sleeve has a relatively thin wall thickness compared to the cylinder 1, typically being approximately 1.00-2.00 mm thick. In this embodiment, the sleeve 14 is continuous but in particular arrangements may have a longitudinal slit, which may extend throughout its length. Alternatively, short slits could be formed adjacent the top and bottom edges of the sleeve. The cylinder and sleeve assembly is rotated about its longitudinal axis la by the reciprocating motion of the piston 6 through a drive mechanism (not shown) in a corresponding cylindrical bore 8 of a fixed valve housing 9 containing an inlet port 10 and an outlet port (not shown). As the cylinder 1 rotates, the inlet port 10 and outlet port are brought successively into alignment with the valve port 7 in the cylinder 1 to enable an air/fuel mix to enter, and exhaust gases to leave, the combustion chamber 5 to enable the engine to operate on the conventional four stroke cycle. The sleeve is a close sliding fit in the cylindrical bore typically having a very small clearance of approximately 0.05 mm. It has been found, surprisingly, that the use of such a thin sleeve as a floating, sliding seal enables very small clearances to be used between the rotating part and the fixed housing 8, which reduces the leakage of combustion gases and oil, without the risk of the engine seizing when hot.

As shown in FIG. 1, the inlet port 10 is inclined downwardly towards the combustion chamber 5 at an angle to a radial plane of the cylinder 1. As can be seen in FIG. 2, the inlet port axis 10a is aligned with the longitudinal axis of the cylinder. It is also possible that the axis of the inlet port could be offset from the axis of the cylinder.

In this embodiment, the valve port 7 is essentially circular in cross-section and is formed by openings 7a, 7b formed in the two sleeves 2, 3 respectively before the two sleeves are fastened together, the two openings 7a, 7b then being aligned to form the port 7. The diameter of the opening 7a in the inner sleeve 2 is smaller than the diameter of the opening 7b in the outer sleeve 3 to thereby form a recess 11 in the outer periphery of the cylinder. The recess 11 is defined by the outer surface of the inner sleeve 2 and the circumferential periphery of the opening 7b in the outer sleeve 3. This can be seen particularly in the exploded view of FIG. 3.

As shown on an enlarged scale in FIG. 6, seal 12 in the form of an annular split ring formed of a resilient material such as spring steel is of generally square cross-section and has a small gap in the split to enable the seal to be compressed against the resilient bias to take up a smaller diameter. In plan view as shown in FIG. 4a and FIG. 4d, when viewed along the longitudinal axis of the cylinder, the seal is arcuate in form to follow the radius of the outer periphery of the cylinder 1. In this way, it is possible to provide an adequate size for the seal without having to increase the thickness of the cylinder to accommodate it, as would be the case if a seal with a planar rear face were used. In an alternative embodiment, the seal may not be split but, by using very tight tolerances, is designed to be a very close sliding fit in the recess, being a sufficiently close fit as to form a static seal between the seal and the recess.

The seal 12 fits into the recess 11 and its resilient bias urges the seal 12 into engagement with the periphery defined by the opening 7b of the recess to thereby provide a static seal to prevent gas leaking round the outside of seal 12. As shown in FIG. 3, an annular spring 13 in the form of a wave washer having substantially the same diameter as the seal 12 is located in the recess 11 between the seal 12 and the outer peripheral surface of the inner sleeve 3 and serves to bias the seal outwardly into contact with the sleeve 14. The seal 12 is located at substantially the same distance from the periphery of the port defined by the opening 7a throughout its length. In this way, the seal 12 is subjected to substantially the same forces of temperature and pressure throughout its length to minimise distortion, and stress distribution, which characteristics can cause a reduction in sealing effect and, possibly, service life.

In operation, during the combustion phase, the hot gases under high pressure impinge upon the seal 12 and act in two directions to supplement the sealing forces generated by the resilience in the seal 12 itself and in the annular spring 13. First of all, the gases act on the rear face of the seal 12, that is its face facing the surface of the inner sleeve 2, to urge the seal 12 outwardly into greater contact with the sleeve 14, and also on the radial inner face of the seal 12 to urge the ring seal outwardly, thus increasing the static sealing force between the seal 12 and the periphery 7b of the recess 11. Thus, the greater the gas pressure acting on the seal 12, the greater the sealing effect generated both in the static seal between the seal 12 and the recess and the seal between the seal 12 and the sleeve 14.

The seal of the present invention has a number of advantages compared with the existing arrangements. First of all, as explained previously, it enables a sufficiently robust seal to be incorporated without having to increase the thickness of the cylinder. It is also possible to provide a valve port of larger diameter than the previous arrangements which, for practical reasons had to be of limited size, which limited the effective size of the inlet duct and lead to inefficient fluid flow paths. With the present invention, the valve port can be made larger than the inlet and/or exhaust port so that the valve will port does not interfere with flow. Furthermore, it will be understood that the size and disposition of the inlet port is a factor in the valve timing of the engine and the present invention facilitates wider variation in the options possible for determining valve timing.

Although described as a circular port with a circular annular seal, it will be understood that the port and seal could be non-circular, such as elliptical, oval or substantially rectangular.

In an alternative embodiment (not shown), the concentric sleeve 14 may be omitted, in which case, the cylinder 1 rotates directly in the cylindrical bore 8 of the fixed valve housing 9. In this way, the seal 12 slides directly on the cylindrical bore 8 and is biassed into the bore surface by the annular spring 13.

Referring now to FIGS. 7 and 8a-8d, there is shown a seal for the inlet port 10 designed to reduce the leakage of gases and fuel from the port into the interior of the engine to reduce the emissions from the engine. Although not illustrated, such a seal may also be provided on the outlet port.

The seal has a seal element 21 located in a circular stepped recess 22 in the fixed valve housing 9 so as to be movable towards and away from the sleeve 14. A coil spring 23, mounted in a spring holder 23a located in the housing 9, serves to bias the seal element 21 into contact with the sleeve 14. The seal 21 has an annular external flange 24 which provides on its face away of the sleeve 14, a location for a spring holder or seat 25 for the spring 23. In an alternative arrangement (not shown), a wave washer spring may be used instead of a coil spring. Although not shown, sealing means, which may comprise a metal sprung ring or a plastics or rubber element, may be provided between a periphery of the sealing element and the valve housing to minimise fluid leakage around the outer periphery of the sealing element.

In another form, the sealing means may consist of a plastics or rubber element, such as an O-ring, resiliently biased into contact with and forming a seal with a radially outer face of the sealing element and also forming a seal with an inner face of a second component mounted on the port radially outside the sealing element, compression of the sealing means also providing a resilient force to resiliently bias the said seal element into contact with the concentric surface.

In yet another form, the sealing means is provided by the sealing element being a close fit within the recess.

As shown particularly in FIG. 8a, the radially innermost (with respect to the axis of rotation of the cylinder) surface 26 of the seal element 21 which abuts the sleeve 14 has an arcuate profile having the same radius as the sleeve 14 to form, when in the installed condition, a close sliding seal with the sleeve. The opening 27 in the seal element 21 is essentially rectangular in this embodiment but may be varied to suit the valve timing and gas flows required. Similarly, the periphery of the element 21 which is slidable in the recess 22 is circular but this may be varied to suit particular installations.

In embodiments of the engine which do not have the sleeve 14, the seal element(s) will abut the cylinder directly and hence the seal element(s) will slide over the seal arrangement on the cylinder. To prevent the seals snagging, the leading edges of the seals, in the direction of rotation, both in the inlet and outlet ports and the seal 12 in the valve port 7 will be chamfered to enable the seals to slide over one another during operation.

1. A seal arrangement for a rotary valve internal combustion engine having a cylinder including a valve port in communication with a combustion chamber, the cylinder being rotatable about its longitudinal axis in a cylindrical bore of a valve housing, the valve housing having an inlet port and an outlet port adapted to be aligned successively with said valve port during rotation of the cylinder in the housing to enable fluid to flow respectively into and out of the combustion chamber, the seal arrangement forming a seal around the valve port between the cylinder and a concentric surface, and comprising a seal element located in a recess in said cylinder, the radially outermost surface of the sealing element forming a sliding seal with the concentric surface and the outer surface(with respect to the axis of the port) of the sealing element forming a static seal with the periphery of said recess, wherein fluid pressure in said valve port acts on said seal element to urge the seal element into contact with the said concentric surface and outwardly from the centre of the port into contact with the periphery of said recess.

2. A seal arrangement according to claim 1, wherein the concentric surface comprises the cylindrical bore of the valve housing.

3. A seal arrangement according to claim 1, wherein the concentric surface comprises the inner surface of a sleeve concentric with the cylinder and engaged to the cylinder so as to be rotationally fast therewith.

4. A seal arrangement according to claim 3, wherein the sleeve is a close sliding fit in the cylindrical bore in the valve housing.

5. A seal arrangement according to claim 3, wherein a predetermined annular gap is provided between the sleeve and the rotatable cylinder, the sleeve being fast to the cylinder so as to be able to float radially relative thereto.

6. A seal arrangement according to claim 5, wherein a locating pin engageable in a bore in the sleeve is located in a bore in the cylinder, the pin being resiliently biased outwardly into engagement with the bore in the sleeve.

7. A seal arrangement according to claim 6, wherein the cross-section of the outer end of the pin which enters the sleeve is smaller than the cross-sectional area of the adjacent part of the pin to provide a shoulder adapted to abut the inner surface of the sleeve thereby to limit the degree of penetration of the pin into the sleeve.

8. A seal arrangement according to claim 7 wherein the pin is circular in cross-section.

9. A seal arrangement according to claim 6, wherein the pin is supported in the bore in the cylinder by a coil spring.

10. A seal arrangement according to claim 3, wherein the sleeve has a longitudinal slit.

11. A seal arrangement according to claim 10, wherein the slit extends throughout the length of the sleeve.

12. A seal arrangement according to claim 1, wherein the profile of the seal element is arcuate about the axis of the cylinder when viewed in the longitudinal direction of the cylinder.

13. A seal arrangement according to claim 1, wherein the seal element is in the form of a split ring and is resiliently biased into the periphery of said recess.

14. A seal arrangement according to claim 1, wherein the seal element extends around the profile of the valve port and is a substantially constant distance from the periphery of the port.

15. A seal arrangement according to claim 1, wherein the seal element comprises a substantially circular split ring.

16. A seal arrangement according to claim 1, wherein the seal element is elliptical, oval or substantially rectangular.

17. A seal arrangement according to claim 1, wherein the seal element is uniform in cross-section.

18. A seal arrangement according to claim 1, wherein the cylinder comprises two concentric sleeves rotationally fast together, the valve port comprising openings extending through the two sleeves, the opening in the outer sleeve being larger than the opening in the inner sleeve to thereby form said recess for the seal element, the recess being formed by the outer surface of the inner sleeve and the peripheral wall of the opening in the outer sleeve.

19. A seal arrangement according to claim 1, wherein the inlet port is inclined at an angle relative to a radial plane of the cylinder.

20. A seal arrangement according to claim 1, wherein the axis of the inlet port extends radially inwardly towards the axis of rotation of the cylinder.

21. A seal arrangement according to claim 1, wherein the axis of the inlet port is offset from the axis of the cylinder.

22. A seal arrangement according to claim 1, wherein a spring element is provided to bias the seal element into contact with said concentric surface.

23. A seal element according to claim 22, wherein the spring element comprises a wave spring washer having substantially the same profile as the seal element.

24. A seal element according to claim 22, wherein the spring element is located in the recess between the seal element and the outer surface of the inner sleeve of the cylinder.

25. A rotary valve internal combustion engine having a cylinder including a valve port in communication with a combustion chamber, the cylinder being rotatable about its longitudinal axis in a cylindrical bore of a valve housing, the valve housing having an inlet port and an outlet port adapted to be aligned successively with said valve port during rotation of the cylinder in the housing to enable fluid to flow respectively into and out of the combustion chamber, wherein a sleeve concentric with the cylinder is rotationally fast thereto in such a way as to be able to float radially relative to the cylinder, the sleeve forming a floating sliding seal between the valve housing and the rotating parts.

26. A rotary valve internal combustion engine according to claim 25, further having a seal arrangement forming a seal around the valve port between the cylinder and a concentric surface, and comprising a seal element located in a recess in said cylinder, the radially outermost surface of the sealing element forming a sliding seal with the concentric surface and the outer surface(with respect to the axis of the port) of the sealing element forming a static seal with the periphery of said recess, wherein fluid pressure in said valve port acts on said seal element to urge the seal element into contact with the said concentric surface and outwardly from the centre of the port into contact with the periphery of said recess.

27. A seal arrangement for a rotary valve internal combustion engine having a cylinder including a valve port in communication with a combustion chamber, the cylinder being rotatable about its longitudinal axis in a cylindrical bore of a valve housing, the valve housing having an inlet port and an outlet port adapted to be aligned successively with said valve port during rotation of the cylinder in the housing to enable fluid to flow respectively into and out of the combustion chamber, the seal arrangement forming a seal around at least one of the inlet port and the outlet port between the valve housing and a concentric surface on the rotatable body, and comprising a seal element located in a recess in said valve housing, the radially innermost surface of the sealing element being arcuate about the axis of the cylinder and being resiliently biased towards the concentric surface, forming a seal with the concentric surface.

28. A seal arrangement according to claim 27, wherein sealing means is provided between the sealing element and the valve housing to minimise fluid leakage around the outer periphery of the sealing element.

29. A seal arrangement according to claim 28, wherein the sealing means comprises a sprung metal ring resiliently biased into contact with and forming a seal with a radially outer face of the sealing element, and being biased outwardly to form a seal with a peripheral surface of the recess.

30. A seal arrangement according to claim 28, wherein the sealing means comprises a plastics or rubber element resiliently biased into contact with and forming a seal with a radially outer face of the sealing element, and being biased outwardly to form a seal with a peripheral surface of the recess.

31. A seal arrangement according to claim 28, wherein the sealing means comprises a plastics or rubber element resiliently biased into contact with and forming a seal with a radially outer face of the sealing element and also forming a seal with an inner face of a second component mounted on the port radially outside the sealing element, compression of the sealing means also providing a resilient force to resiliently bias the said seal element into contact with the concentric surface.

32. A seal arrangement according to claim 28, wherein the sealing means is provided by a plastics or rubber element located on a radially outer surface of the sealing element, forming a seal with said outer surface of the sealing element and a periphery of the recess.

33. A seal arrangement according to claim 28, wherein the sealing means is provided by the sealing element being a close fit within the recess.

34. A seal arrangement according to claim 27, further including a seal located on the seal element and being biased outwardly into contact with the periphery of the recess to form a static seal.

35. A seal arrangement according to claim 27, wherein the sealing element is biased into contact with the concentric surface by a coil spring or wave washer.

36. A seal arrangement according to claim 28, wherein the sealing element is biased into contact with the concentric surface by a coil spring or wave washer.
